(19) United States
(12) Patent Application Publication
(10) Pub. No.: US 2010/0315544 A1
(43) Pub. Date: Dec. 16, 2010

(54) IMAGER THAT PHOTOGRAPHS AN IMAGE USING A PUPIL-DIVIDING AUTOFOCUS MECHANISM

(75) Inventor: Yasuhiro YAMAMOTO, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/814,622

(22) Filed: Jun. 14, 2010

(30) Foreign Application Priority Data
Jun. 16, 2009 (JP) 2009-143439

(51) Int. Cl. H04N 5/232; H04N 5/222

(52) U.S. Cl. 348/333.12; 348/349; 348/333.01; 348/E05.022; 348/E05.045

(57) ABSTRACT

An imager is provided having an imaging sensor, a pupil divider and a display. The imaging sensor photographs a subject image obtained through a photographing lens, and outputs image data. The pupil divider has shutters positioned in a light path between the photographing lens and the imaging sensor. The display displays an image using the image data photographed by the imaging sensor. The shutters periodically blocks part of the light path. The imaging sensor outputs multiple image data by photographing a subject image passing through a light path that is not blocked by the shutters. The display displays multiple image data that is compensated for shifts between subject images in the multiple image data.

### BACKGROUND OF THE INVENTION

1. Field of the Invention

The present invention relates to an imager equipped with an imaging sensor that captures an image using a pupil-dividing auto focus mechanism.

2. Description of the Related Art

A well-known imager provides a pupil divider between a photographing lens and an imaging sensor to open and close a light path, and determines whether a subject image is in focus by comparing images passing through different light paths. The pupil divider comprises a liquid crystal shutter array that divides the light path from the photographing lens to the imaging sensor. The subject images passing through different light paths are formed on the same position of the imaging sensor when the photographing lens is focused accurately, but they are not formed on the same position when the photographing lens is not properly focused. Japanese Unexamined Patent Publication No. H06-175015 discloses an imager that exhibits on a display a through image photographed by an imaging sensor.

In the case that such an imager displays through images comprising images that have passed through different paths, the subject images arriving through different optical paths overlap with one another when the photographing lens is not accurately focused. Therefore, the displayed through image is unsightly.

### SUMMARY OF THE INVENTION

An object of the present invention is to provide an imager that has a pupil-dividing auto focus mechanism and displays a through image so that the subject images do not overlap when the photographing lens is not accurately focused.

An imager is provided having an imaging sensor, a pupil divider and a display. The imaging sensor photographs a subject image obtained through a photographing lens, and outputs image data. The pupil divider has shutters positioned in a light path between the photographing lens and the imaging sensor. The display displays an image using the image data photographed by the imaging sensor. The shutters periodically blocks part of the light path. The imaging sensor outputs multiple image data by photographing a subject image passing through a light path that is not blocked by the shutters. The display displays multiple image data that is compensated for shifts between subject images in the multiple image data.

### BRIEF DESCRIPTION OF THE DRAWINGS

The objects and advantages of the present invention will be better understood from the following description, with references to the accompanying drawings in which:

FIG. 1 is a perspective view of an imager as seen from a rear surface according to the present embodiment;

FIG. 2 is a block diagram of the imager;

FIG. 3 is a perspective view of a pupil divider;

FIG. 4 shows a light path when the photographing lens is not accurately focused;

FIG. 5 shows a light path when the photographing lens is not accurately focused;

FIG. 6 shows overlapping subject images;

FIG. 7 is a flowchart of a preparation process;

FIG. 8 shows subject images for which an overlap has been rectified;

FIG. 9 is a flowchart of a display process; and

FIG. 10 shows subject images for which an overlap has been rectified by the display process.

### DESCRIPTION OF THE PREFERRED EMBODIMENTS

The present invention is described below with references to the embodiment shown in the drawings.

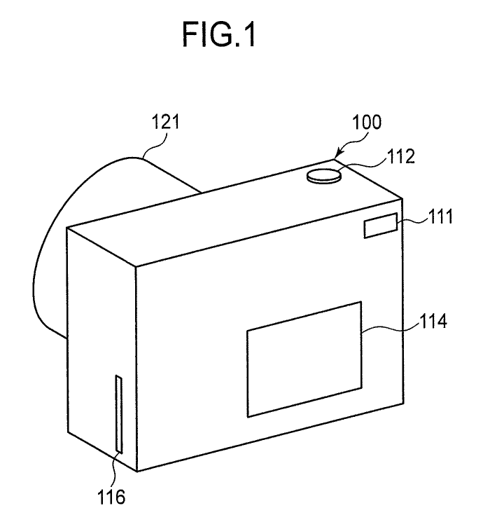

FIG. 1 shows a digital camera 100 that is an imager according to the first embodiment. For example, the digital camera 100 is a single-lens reflex camera.

The digital camera 100 is equipped with a main power switch 111 that activates and deactivates a main power source, a release button 112, a LCD monitor 114, a card slot 116, and a photographing lens 121 that projects from the front surface of the digital camera. The main power switch 111 and the release button 112 manipulate an operation switch 110.

The main power switch 111 is a momentary switch projecting from the back surface of the digital camera 100. The digital camera is powered on when a user depresses the main power switch 111. In the case that a user depresses the main power switch 111 while the digital camera 100 is powered, the digital camera 100 is powered off.

The release button 112 is a two-step momentary switch provided on the top of the digital camera 100. In the case that a user depresses the release button 112 halfway, the digital camera carries out photometry and distance surveying processes. In the case that a user fully depresses the release button 112, the digital camera captures an image.

The LCD monitor 114 is rectangular-shaped with the same 3:4 aspect ratio as a photographed image. As illustrated in FIG. 1, it is a rectangle of which the long sides extend in the longitudinal direction of the digital camera 100, and it is provided near the center on the back surface of the digital camera 100. It displays a through image and an image obtained through the photographing lens 121, a photographed image, and configuration settings of the digital camera 100.

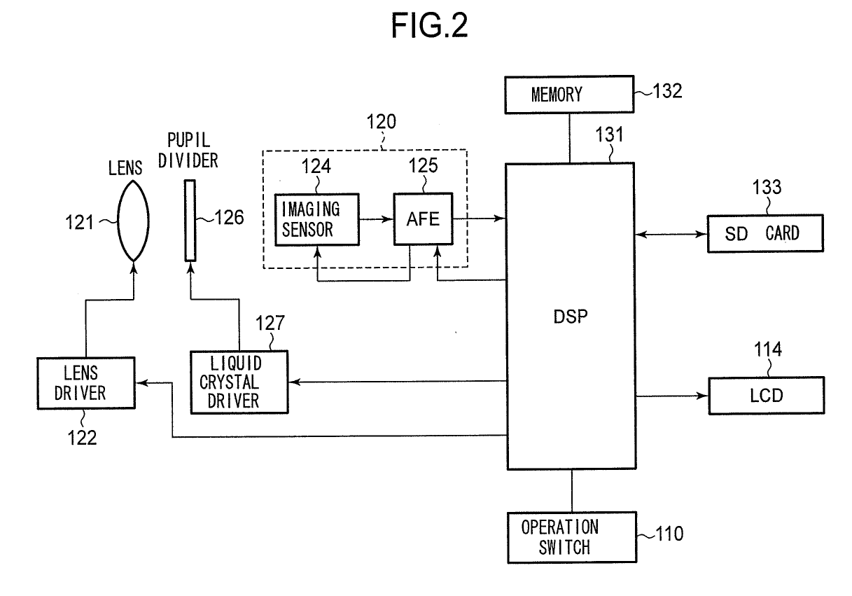

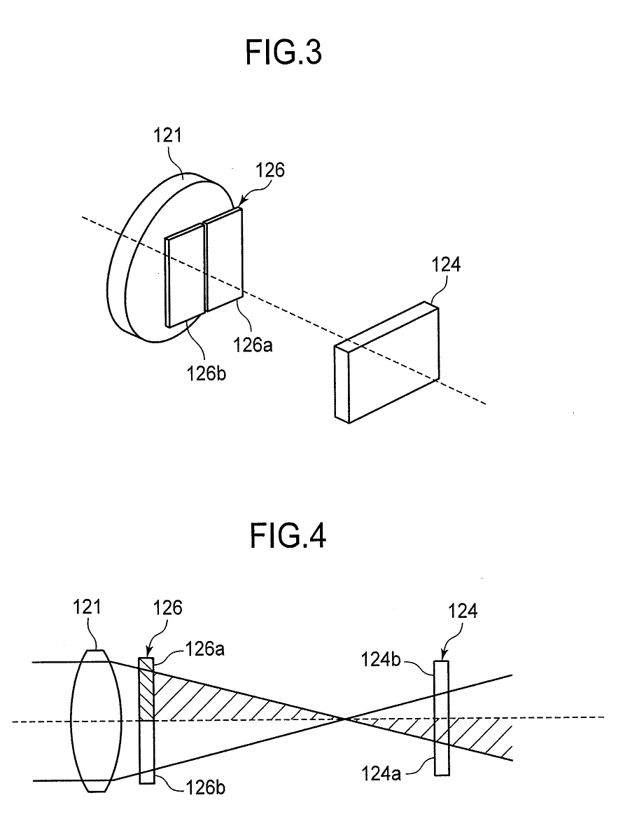

Certain components provided in the digital camera are described with reference to FIG. 2. The digital camera 100 mainly comprises a DSP 131 that controls the operation of the digital camera 100, an operation switch 110 that is used for operating the digital camera 100, an imaging unit 120 that converts a subject image to a digital image signal, a memory 132 that stores data sent from the DSP 131, a SD card 133 that stores a photographed image, the LCD monitor 114, a pupil divider 126 that divides the light path from the photographing lens 121, a liquid crystal driver 127 that drives the pupil divider 126, a photographing lens 121, and a lens driver 122 that drives the photographing lens 121.

The imaging unit 120 mainly comprises an imaging sensor 124 and an AFE (Analog Front End) 125.

The imaging sensor 124 comprises a CCD or CMOS, and has an imaging area that converts an incoming subject image to an analog image signal. The photographing lens 121 focuses a subject image on the imaging area of the imaging sensor 124. The imaging area is rectangular-shaped, and is configured in the digital camera 100 so that the long side of the imaging area is coincident with the direction from right to left of FIG. 1 and the short side of the imaging area is coincident with the direction from top to bottom of FIG. 1.

The imaging sensor 124 converts a subject image formed on the imaging area to an analog image signal, and sends it to the AFE 125. The AFE 125 converts an analog image signal to a digital image signal after adjusting the gain of the analog image signal, and then sends the digital image signal to the DSP 131.

The pupil divider 126, which has a first liquid crystal shutter 126a and a second liquid crystal shutter 126b, is provided in the light path of the photographing lens 121 and blocks the light path to the imaging sensor 124. The first liquid crystal shutter 126a and second liquid crystal shutter 126b are aligned in the horizontal direction, i.e. in the transversal direction of the digital camera 100. When the photographing lens 121 is seen from the imaging sensor 124, the first liquid crystal shutter 126a is provided in the right half of the light path, and the second liquid crystal shutter 126b is provided in the left half of the light path. The first liquid crystal shutter 126a and the second liquid crystal shutter 126b divide the light path in two. The first liquid crystal shutter 126a and the second liquid crystal shutter 126b each comprise liquid crystal. When the liquid crystal driver 127 applies voltage to them, they block the light path. When the DSP 131 sends a switching signal to the liquid crystal driver 127, the liquid crystal driver 127 applies voltage to the first liquid crystal shutter 126a and the second liquid crystal shutter 126b. The first liquid crystal shutter 126a and the second liquid crystal shutter 126b alternatingly shield the light path. That is, when the first liquid crystal shutter 126a opens the light path the second liquid crystal shutter 126b blocks the light path, and when the first liquid crystal shutter 126a blocks the light path the second liquid crystal shutter 126b opens the light path.

Before imaging, the DSP 131 carries out photometry processing of a subject using the quantity of light from the subject image that is included in the digital image signal. It calculates an exposure value using the photometry value, and then calculates the shutter speed and aperture value that are used in photographing. Afterward, a photograph is taken based on the calculated shutter speed and aperture value.

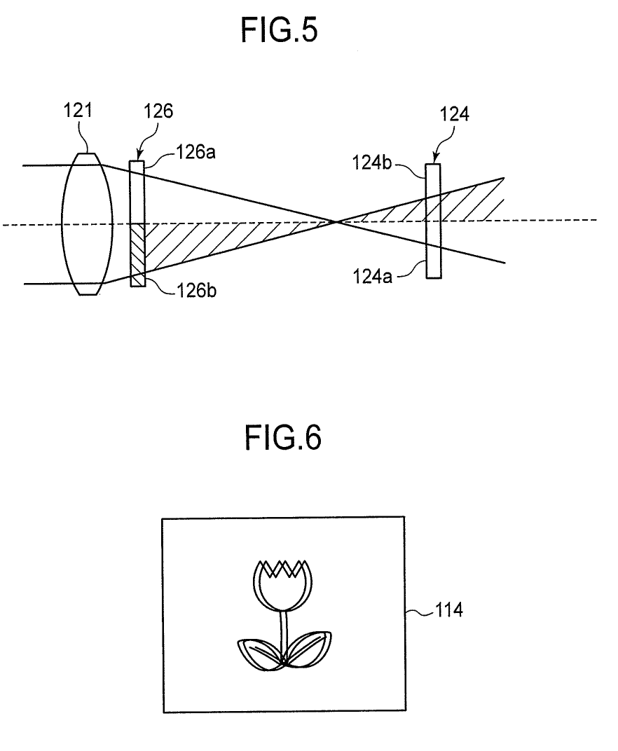

The DSP 131 executes a phase difference AF process. The phase difference AF process focuses the photographing lens 121 on a subject using the pupil divider 126. More precisely, the DSP drives the first liquid crystal shutter 126a and the second liquid crystal shutter 126b so as to alternatingly block the light path per a predetermined cycle. When the first liquid crystal shutter 126a opens the light path, light passes through the first liquid crystal shutter 126a and strikes the imaging sensor 124 (refer to FIG. 4). Similarly, when the second liquid crystal shutter 126b opens the light path, light passes through the second liquid crystal shutter 126b and strikes the imaging sensor 124 (refer to FIG. 5). When a subject image is focused on the imaging sensor 124, a subject image passing through the first liquid crystal shutter 126a and a subject image passing through the second liquid crystal shutter 126b correspond to each other on the imaging surface 124. The DSP 131 processes a digital image signal received from the AFE 125 and drives the photographing lens 121 to focus a subject image on the imaging sensor 124, so that a subject image passing through the first liquid crystal shutter 126a and a subject image passing through the second liquid crystal shutter 126b correspond to each other on the imaging surface 124. After the photographing lens 121 is focused on a subject, the DSP 131 executes an AF lock, which locks in place the focusing optical system of the photographing lens 121.

After receiving a digital image signal from the AFE 125, the DSP 131 processes the digital image signal and creates frame image data, which contains the data of one frame of an image. The frame image data is displayed on the LCD monitor 114 as a through image.

During photographing the DSP 131 processes the received digital image signal and creates frame image data that contains the data of one frame of a captured image. The frame image data is stored in the SD card 133 and displayed on the LCD monitor 114. The memory 132 is used as a working memory where intermediate data is temporarily stored while the DSP 131 carries out image processing.

The SD card 133 is detachably stored in the card slot 116 provided on the side surface of the digital camera 100. A user can change a SD card 133 by accessing the card slot 116 from the exterior of the digital camera 100.

In the case that the photographing lens 121 is focused on a subject with the pupil divider 126, a subject image passing through the first liquid crystal shutter 126a and the second liquid crystal shutter 126b reach the imaging sensor 124 on an alternating basis. Therefore, when the photographing lens 121 is not accurately focused, subject images that are not in focus will appear as overlapping double images on the imaging sensor 124. That is, In the case that the LCD monitor 114 displays a through image, the subject images that are not in focus are displayed as overlapping double images on the imaging sensor 124 (refer to FIG. 6). It causes an unsightly image to be displayed and gives a user the impression that the digital camera 100 is broken. To prevent the display of such a degraded image, the process described hereinafter is performed.

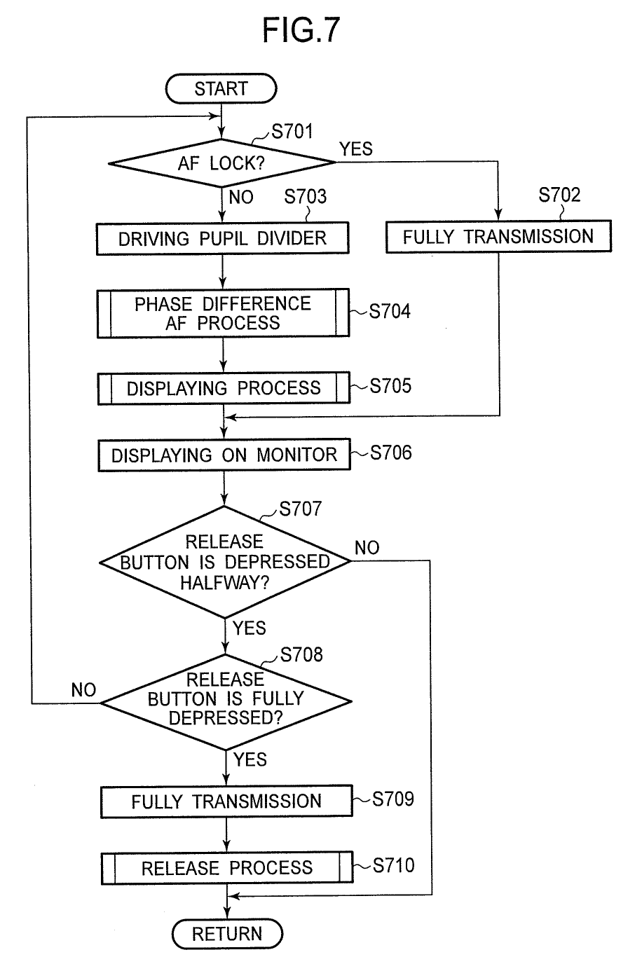

A preparation process is described hereinafter with reference to FIG. 7. The preparation process begins with the DSP 131 when the release button 112 is depressed halfway.

In Step S701, a determination is made as to whether or not the photographing lens 121 is under the AF lock condition. In the case that the AF lock is in effect, the process proceeds to Step S702 and the AF procedures, etc. in Steps S703 to S705 are not carried out because the photographing lens 121 is regarded as already being focused on a subject.

In Step S702, the DSP 131 sends signal to the liquid crystal driver 127 for the pupil divider 126 to open the light path. The pupil divider 126 then opens the light path. After that, the process proceeds to Step S706.

In the case that the AF lock is not in effect, the AF procedures, etc. in Steps S703 to S705 are carried out because the photographing lens 121 is not regarded as being focused on a subject.

In Step S703, the DSP 131 sends a signal to the liquid crystal driver 127 for the pupil divider 126 to repetitively block and unblock the light path. The pupil divider 126 then repetitively blocks and unblocks the light path.

Next in Step S704, the phase difference AF process is carried out. At the same time the phase difference AF process is carried out, the display process in Step S705 and actual display on the monitor in Step S706 are performed concurrently.

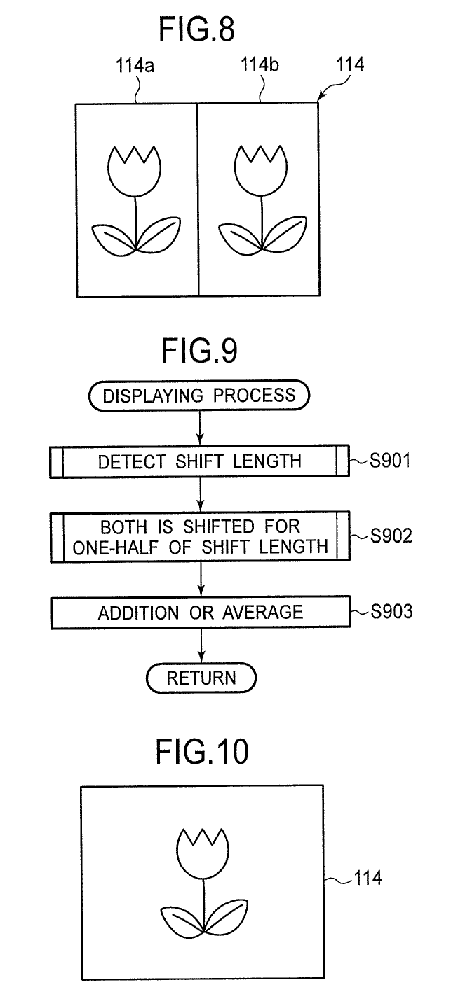

A subject image is not in focus on the imaging sensor 124 while the display process in Step S705 and actual display on the monitor in Step S706 are performed. To prevent an overlapping double image of the subject from being displayed on the LCD monitor 114, the display area of the LCD monitor 114 is divided in two so that a left side area and a right side area are created, where the left side area displays an image passing through the first liquid crystal shutter 126a while the right side area displays an image passing through the second liquid crystal shutter 126b (refer to FIG. 8). Thereby, an overlapping double image of a subject is not displayed on the LCD monitor 114.

In Step S707, whether or not the release button 112 is depressed halfway is determined. In the case that it is not depressed halfway, the process ends. In the case that it is depressed halfway, the process proceeds to Step S708.

In Step S708, whether or not the release button 112 is fully depressed is determined. In the case that it is not fully depressed, the process returns to Step S701. In the case that it is fully depressed, the process proceeds to Step S709.

In Step S709, the DSP 131 sends a signal to the liquid crystal driver 127 for the pupil divider 126 to open the light path. The pupil divider 126 then opens the light path. Afterward, the process proceeds to Step S710.

In Step S710, a subject is photographed by conducting the release process, and the photographed image data is stored in the SD card 133. Afterward, the process ends.

According to the embodiment, a through image is not displayed as an overlapping double image on the LCD monitor 114 while a subject is photographed using the pupil dividing auto focus mechanism.

Note that, in the display process of Step S705 and actual display on the monitor in Step S706, the display area of the LCD monitor 114 need not be divided in two areas, the display area may instead display either one of the images passing through the first liquid crystal shutter 126a or the second liquid crystal shutter 126b. Thereby, a through image is not displayed as an overlapping double image on the LCD monitor 114.

Note that, in the display process of Step S705 and the actual display on the monitor in Step S706 the display area of the LCD monitor 114 need not be divided in two areas, the display area may instead display an image that is created from either the addition or average of the pixels that form an image passing through the first liquid crystal shutter 126a or the second liquid crystal shutter 126b.

The second embodiment according to the invention is described with references to FIGS. 9 and 10. The constructions of the second embodiment that are similar to the first embodiment have the same numeral applied and their descriptions have been omitted.

In the second embodiment the display process is different from that of the first embodiment. Hereinafter, the display process is described with respect to the second embodiment.

In Step S901, the DSP 131 calculates a shift length, which is the length on the imaging sensor 124 between the subject image passing through the first liquid crystal shutter 126a and the subject image passing through the second liquid crystal shutter 126b. For example, the shift length is calculated for the image in the central portion of the imaging sensor 124. As shown in FIG. 6, when subject images do not coincide on the imaging sensor 124, the length between these images is defined as the shift length.

In Step S902, a subject image passing through the first liquid crystal shutter 126a is shifted by one-half of the shift length in the right direction. Then, a subject image passing through the second liquid crystal shutter 126b is shifted by one-half of the shift length in the left direction.

In Step S903, the two shifted images are added or averaged. Afterward, the added image or the averaged image is displayed on the LCD 114 in Step S706 of the preparation process (refer to FIG. 10). The addition or average calculations are based on every pixel. Thereby, a through image is not displayed as an overlapping double image on the LCD monitor 114.

According to the second embodiment, a through image is not displayed as an overlapping double image on the LCD monitor 114, and the displayed position of the subject image is approximately the same as the position of a focused subject image on the LCD monitor 114 when the subject is photographed using the pupil dividing auto focus mechanism.

An additional advantage of the embodiment is a faster focusing speed that uses the pupil-dividing auto focus mechanism to display a through image where subject images are not displayed as overlapping double images on the LCD monitor 114, because a subject that is photographed using the pupil-dividing auto focus mechanism has a faster focusing speed than the contrast AF process.

In the case that the reading period (frame rate) of the imaging sensor 124 is increased, the photographed image might darken because charging time is shortened and the amount of light received by the imaging sensor 124 is reduced accordingly. However, the darkened photographed image can be prevented by carrying out the additional procedure of Step S903.

Note that, in the case of using the pupil dividing auto focus mechanism, the frame rate of the imaging sensor 124 may be increased. For example, the frame rate may be doubled from 30 fps to 60 fps. Therefore, a through image is smoothly displayed on the LCD monitor 114 without awkward movement.

In Step S902, the subject images passing through the first liquid crystal shutter 126a and the second liquid crystal shutter 126b need not both be shifted, instead only one of either one of the subject images may be shifted by the shift length.

Step S903 need not be processed, instead any one of the subject images passing through the first liquid crystal shutter 126a and the second liquid crystal shutter 126b may be shifted by the shift length, and the shifted subject image and the unshifted subject image are displayed alternatingly on the LCD monitor 114.

The liquid crystal driver 127 may enable light to pass by applying voltage to the first liquid crystal shutter 126a and the second liquid crystal shutter 126b.

The first liquid crystal shutter 126a and the second liquid crystal shutter 126b need not be limited to a shutter having a liquid crystal, and may instead be a shutter having a shutter curtain.

Although the embodiment of the present invention has been described herein with references to the accompanying drawings, obviously many modifications and changes may be made by those skilled in the art without departing from the scope of the invention.

The present disclosure relates to subject matter contained in Japanese Patent Application No. 2009-143439 (filed on Jun. 16, 2009), which is expressly incorporated herein, by reference, in its entirety.

1. An imager comprising:
an imaging sensor that photographs a subject image obtained through a photographing lens, and outputs image data;
a pupil divider that has shutters positioned in a light path between the photographing lens and the imaging sensor; and
a display that displays an image using the image data photographed by said imaging sensor;
said shutters periodically blocking part of the light path;
said imaging sensor outputting multiple image data by photographing a subject image passing through a light path that is not blocked by said shutters;
said display displaying multiple image data that are compensated for shifts between subject images in the multiple image data.

2. The imager according to claim 1 further comprising a shift length detector that detects a shift between subjects in the multiple image data, and wherein said display displays the multiple image data while compensating the position of each image data with the shift length, so that the positions of subject images in the multiple image data correspond to one another on the images.

3. The imager according to claim 1 further comprising a shift length detector that detects a shift between subjects in the multiple image data, and wherein said display compensates the position of each image data with the shift length so that the positions of subject images in the multiple image data correspond to one another on the images, and thereby displays composite image data created by adding or averaging pixel signals of the multiple compensated image data for each pixel.

4. The imager according to claim 1, wherein said display displays composite image data created by adding or averaging pixel signals of the multiple image data for each pixel.

5. The imager according to claim 1 further comprising a shift length detector that detects a shift between subjects in the multiple image data and executes a phase difference auto focus that focuses a lens on a subject based on the shift.

6. The imager according to claim 1, wherein said display shifts either one of two subject images passing through the shutters by the shift length, and displays alternatingly the shifted subject image and the unshifted subject image.

7. An imager comprising:
an imaging sensor that photographs a subject image obtained from a photographing lens and outputs image data;
a pupil divider that has shutters provided in a light path from the photographing lens to the imaging sensor; and
a display that displays an image using the image data photographed by said imaging sensor;
said shutters periodically block a part of the light path;
said imaging sensor outputting multiple image data by photographing a subject image passing through a light path that is not blocked by said shutters;
said display having multiple display areas, and displaying each image data output by said imaging sensor on each display area.

8. An imager comprising:
an imaging sensor that photographs a subject image obtained from a photographing lens, and outputs image data;
a pupil divider that has shutters provided in a light path from the photographing lens to the imaging sensor; and
a display that displays an image using the image data photographed by said imaging sensor;
said shutters periodically blocking a part of the light path;
said imaging sensor outputting image data by photographing a subject image passing through a light path that is not blocked by said shutters;
said display displaying only image data obtained by photographing a subject image passing through a light path that is not blocked by said shutters.

9. The imager according to claim 8, wherein said imaging sensor has multiple pixels, and wherein said imaging sensor reads charges from the pixels for a shorter period in the case that said display displays image data obtained by photographing a subject image passing through a light path that is not blocked by said shutters.
